(19) United States
(12) Patent Application Publication
(10) Pub. No.: US 2008/0006604 A1
(43) Pub. Date: Jan. 10, 2008

(54) Devices and methods for using electrofluid and colloidal technology

(76) Inventor: John P. Keady, San Jose, CA (US)

Correspondence Address: Dr. John P. Keady;Personics Holdings Inc., Tower 2, Suite 510, 5100 Town Center Circle, Boca Raton, FL, 33486, US

(21) Appl. No.: 11/265,041

(22) Filed: Nov. 2, 2005

Related U.S. Application Data
(60) Provisional application No. 60/668,947, filed on Apr. 7, 2005.

(51) Int. Cl. B44C 1/22; C23F 1/00

(52) U.S. Cl. 216/83; 216/86; 216/87

(57) ABSTRACT

At least one exemplary embodiment is directed to a device that uses a charged photoresist which is subsequently patterned by electric and/or magnetic fields and subsequently exposed and developed to provide an etchable pattern in a semiconductor substrate.

### CROSS-REFERENCE TO RELATED APPLICATIONS

This application claims the benefit of U.S. provisional patent application No. 60/668,947 filed on 7 Apr. 2005, incorporated herein by reference in it's entirety.

### FIELD OF THE INVENTION

The invention relates in general to devices and methods of electrofluid and colloidal technology.

### BACKGROUND OF THE INVENTION

In 1988 Dr. Keady developed one of the first co-axial electrofluid devices, which charged droplets of water and kerosene, and deflected the droplets in an electric field. Electrified fluid can impact many future industries, propulsion, detector designs, manufacturing, optics, power generation and transfer, shielding, nanotechnology, and semiconductor structure formation, to mention just a few. FIG. 1 illustrates the conventional charged system developed by Dr. Keady in 1988 to charge a co-axial fluid. The system was described at a NASA Langley conference in 1988 as a student paper and presentation.

The conventional system comprises a coaxial supply system to deliver an inner fluid surrounded by an outer fluid. FIG. 1 illustrates the conventional co-axial fluid production and charging unit 100 comprising an inner fluid reservoir 160 and an outer fluid reservoir 105. The inner fluid reservoir 160 feeds the inner fluid stream 164 and the outer fluid reservoir 105 feeds the outer fluid stream 162. The unit 100 is connected to a shaker motor via a shaker arm 125 which can be used to shake the unit 100 at a chosen frequency, which can be zero. The shaking can form uniform droplets or multi-fluid droplets (aphrons) 170 comprised of an inner core 174 surrounded by an outer sheath 172. An electrode 140 (e.g., with diameter D0) is voltage biased V0 with respect to the unit 100. The voltage bias drives electrons away from the droplet formation point resulting in droplets 170 having a net charge which can be deflected via electric fields later.

Aphron Production

The book by Felix Sebba entitled “Foams and Biliquid Foams—Aphrons”, John Wiley & Sons, 1987, incorporated herein by reference, is an excellent source on the preparation and properties of aphrons in aqueous fluids. Aphrons are made up of a core which is often spherical of an internal phase, usually liquid or gas, encapsulated in a thin liquid shell of the continuous phase liquid. This shell contains surfactant molecules so positional that they produce an effective barrier against coalescence with adjacent aphrons.

Charged Fluid Technology

Plasma physicist sometimes refer to a charged fluid, when discussing some forms of plasmas. However, they are typically not discussing a true charged fluid (e.g., charged molten metal or charged water with impurities). Charged droplets have been used in coating devices. In electrostatic coating, the fluid is atomized, then negatively. The part to be coated is electrically neutral, making the part positive with respect to the negative coating droplets. The coating particles are attracted to the surface and held there by the charge differential until cured.

With an electrostatic spray gun, the droplets pick up the charge from an electrically charged electrode near but not part of the tip of the gun. The charged fluid is given its initial momentum from the fluid pressure/air pressure combination. The charged droplets tend to be attracted to the sides of the recess and sharp edges instead of penetrating to the bottom. The use of electrospray systems requires all electrically conductive materials near the spray area such as the material supply, containers, and spray equipment to be grounded to prevent static buildup. All equipment (e.g., hangers, conveyors) must be kept clean to ensure conductivity to ground. Charges build up on ungrounded surfaces. Operators grounding out these surfaces may receive a severe electrostatic shock.

Charging a fluid can be facilitated by adding an electrolyte. An electrolyte is a substance (usually a fluid) which has movable ions (electrically charged molecules or atoms) dissolved in it which make it electrically conductive, and which allow it to undergo electrolysis. An electrolyte may be a solution, a liquid compound or a solid (e.g., cations, anions, mono-substituted imidazoliums, di-substituted imidazoliums, tri-substituted imidazoliums, substituted pyridiniums, substituted pyrolidiniums, tetraalkyl phophoniums, tetraalkyl ammoniums, guanidiniums, uroniums, thiouroniums, alkyl sulfates and sulfonates, halides, amides and imides, tosylates, borates, phosphates, antimonates, carboxylates, and other substances as known by one of ordinary skill in the relevant arts and equivalents, for example similar compounds as listed in Merck's™ “Ionic Liquids”, May 2005).

Propulsion Historical Review

(From U.S. Pub. No. 2004-0226279, by Fenn. Filed 13 May 2003)

The following review is repeated here from U.S. Pub. No. 2004-0226279. No admissions of prior art is made in the present application, instead the review is repeated herein for instructional purposes only.

Charged droplets as propellants has its roots in studies carried out during World War I by John Zeleny, a physicist at Yale. He found that if a small bore thin walled tube was maintained at a high electrostatic potential relative to its surroundings or an opposing electrode, the electric field at the tube tip could be sufficiently intense to disperse an emerging conducting liquid into the ambient gas (air) as a fine spray of charged droplets [J. Zeleny, Proc. Phil. Soc. (Camb.) 18, 71 (1915); Phys. Rev.3, 68 (1914)]. (These tubes are frequently referred to as “spray needles” because they often comprise a short length of the stainless steel tubing from which hypodermic needles are produced.) Except for an occasional paper, this “electrospray” phenomena remained pretty much a laboratory curiosity until the 1960's when two prospective applications for sprays of charged droplet emerged. First came the realization that nonvolatile liquids could be electrosprayed into vacuum wherein electrostatic acceleration of the droplets to high velocities might be a useful source of thrust for vehicle propulsion in space.

Earlier studies on the development of “ion engines” based on the acceleration of atomic ions had shown that very high specific impulses could indeed be achieved. However, to achieve useful ratios of thrust to power would require “ions” with much higher mass/charge ratios than ions comprising electron deficient atoms could provide.

Thus, Krohn [V. E. Krohn, in Progress in Astronautics and Rocketry, Vol. 5, A.C. Press, NY& London (1961); ARS Electric Propulsion Conference, Berkeley, Calif. (1962)], Huberman [M. N. Huberman, J. Appl. Phys. 41, 578 (1970)], Huberman and Rosen [M. N. Huberman and S. G. Rosen, J. Spacecraft, 11, 475 (1974)], Kidd and Shelton [P. W. Kidd and H. Shelton, paper at ARS 10th Electric Propulsion Conference, Berkeley, Calif. (1962)] and others had carried out studies on the thrust produced by acceleration of charged liquid droplets. In 1999 Martinez Sanchez et al provided an extensive review of the research on what is often referred to as Colloid Propulsion (CP) [M. Martinez-Sanchez, J. Fernandez de la Mora, V. Hruby, M. Gamero-Castano and V. Khayms, 26th Int'l Electric Propulsion Conference, Kitakyushu, Japan (1999)]. More recently, Gamero Castano and Hruby have provided detailed results obtained during an extensive study on the performance of such a thruster over a range of operating conditions and liquid composition [M. Gamero-Castano and V. Hruby, AIAA, 2000 pg. 3265].

The second prospective and intriguing possible application for Zeleny's charged droplets was proposed in 1968 by Malcolm Dole [M. Dole, L. L. Mach, R. L. Hines, R. C. Mobley, L. P. Ferguson, M. B. Alice, J. Chem. Phys. 49, 2240 (1968)]. Zeleny had noticed that if the liquid were volatile, evaporation would shrink each charged droplet until at some point it would become unstable and suddenly disrupt into a plurality of smaller “offspring” droplets. The disruption was due to the increase in droplet charge density occasioned by evaporative shrinking to the point where Coulomb repulsion overcame the surface tension that held the droplet together. This instability disruption phenomenon, sometimes referred to as a Coulomb explosion, had been predicted and characterized in 1882 by Lord Rayleigh [Rayleigh, Phil. Mag. 14,184(1882)].

Dole's idea was that the “offspring” droplets resulting from the Rayleigh instability would repeat the evaporation disruption sequence. If the electrosprayed liquid comprised a dilute solution of large polymer molecules in a volatile solvent, a series of these evaporation disruption sequences should ultimately produce droplets so small that each one would contain only a single polymer molecule. As the last of the solvent evaporated that molecule would retain some of its droplet's charge and thus form an intact gaseous ion, even from a species much too large and fragile to be vaporized for ionization by traditional methods such as Electron Impact (EI). Dole hoped that analysis of the resulting ions with a mass spectrometer would provide a route to the long sought goal of determining the molecular weight distributions in synthetic polymers. Unfortunately, for a number of reasons, his attempts to reduce this idea to experimental practice were not successful enough to spark much interest in other investigators.

In 1974, consequent to their previous research in producing charged droplets for Colloidal Propulsion (CP) Simons et al introduced Electrohydrodynamic Ionization (EHDI) by reporting the production of ions from some solute species in charged droplets of solutions electrosprayed directly into vacuum. In order to avoid “freeze drying” of the liquid droplets due to rapid evaporation rate in vacuo they had to use nonvolatile solvents such as glycerol [D. S. Simons, B. N. Colby, C. A. Evans, Jr., Int. J. Mass Spectrom Ion Phys. 5, 467 (1974).]. The low volatility of these liquids together with the absence of ambient bath gas as a source of evaporation enthalpy made droplet vaporization too slow to be completed so that ion yields were low.

Even so, for the next decade or so several investigators pursued EHDI but it never achieved much of a following. Not only did the absence of bath gas inhibit droplet evaporation it also eliminated most collisions between any ions that were formed and neutral gas molecules. The net result was that the ions retained much of the kinetic energy with which they were born, i.e. a substantial fraction of the difference in potential between the source needle and ground or counter electrode. Thus, most ion energies were in the range of one or more kilovolts, so high that the only mass analyzers that could accommodate them were large and very expensive magnetic sector instruments. For these and other reasons EHDI never became a viable ionization method. In 1986 Cook published a fairly comprehensive review of EHDI research up to that time [K. Cook, Mass Spectrom. Rev. 5, 467 (1986)]. Not much has happened since then.

In 1984 Yamashita and Fenn at Yale [M. Yamashita and J. B. Fenn, J. Phys. Chem. 88,4451(1984); ibid.88,4- 471(1984)] as well as Alexandrov et al in Leningrad [M. L. Alexandrov, L. N. Gall, V. N. Krasnov, V. I. Nikolaev, V. A. Pavlenkom, V. A. Shkurov, Dokl. Akad. Nauk SSSR, 277, 379 (1984)] both showed that if certain precautions were observed Dole's idea of electrospraying solutions into bath gas worked very well in producing ions with small solute molecules.

A few years later the Yale Group showed that EDI could produce intact ions from proteins having molecular weights of at least 50,000 with no evidence of any upper limit in size [J. B. Fenn, M. Mann, C. K. Meng, S. F. Wong, C. M. Whitehouse, Science, 246, 64(1989) ]. Moreover, the number of charges per ion increased with molecular weight so that the mass/charge ratio hardly ever exceeded about 2500.

There are major differences between these two applications of Zeleny's electrospray dispersion, i.e. the use of charged droplets as a source of ions for mass spectrometry, or as a “working fluid” in Colloidal Propulsion (CP) thrusters. In ESIMS the liquids have to be sufficiently volatile to evaporate fairly quickly and the droplet must be dispersed in a gas at a temperature and pressure sufficiently high to provide the enthalpy necessary for evaporating the solvent. In CP thrusters the sprayed liquids are as non-volatile as possible and are dispersed into vacuum. Even so, the fundamental processes of dispersing the liquid into charged droplets by electrostatic fields are very similar in the two cases.

The Spray Stability Problem

(From U.S. Pub. No. 2004-0226279, by Fenn. Filed 13 May 2003)

Microscopic examination of a stable electrospray shows that the liquid emerging from the tip of the spray needle forms a conical meniscus known as a Taylor cone in honor of G. I. Taylor whose theoretical analysis predicted that a dielectric liquid in a high electric field would take such a shape [G. I. Taylor, Proc. Roy. Soc. A 280, 383 (1964)]. In the case of conducting liquids a fine filament or jet of liquid emerges from the cone tip. An interaction between surface tension and viscosity, also first analyzed by Rayleigh, produces so-called varicose waves along the jet surface [Rayleigh, The Theory of Sound, Vol II. Chap. XX (Dover, N.Y. (1945]. Those waves grow in magnitude to the point where they pinch off segments of the filament having a uniform length. Surface tension transforms each such segment into a spherical droplet. The net result is a stream of droplets of uniform size with diameters slightly larger than the diameter of the jet. Because all the droplets have a net charge of the same polarity, Coulomb repulsion disperses their trajectories into a conical array. Sprays produced under these circumstances are often known as “conejet” sprays.

It turns out that to obtain a stable conejet electrospray one can achieve and maintain an optimum balance between liquid flow rate and the applied field. Moreover that optimum balance depends very strongly on the properties of the liquid, in particular its electrical conductivity, surface tension and viscosity. In general, the higher the conductivity and surface tension, the lower must be the flow rate. Introduction of liquid at a desired rate is usually achieved either with a positive displacement pump or by pressurizing a reservoir of the sample liquid with gas. In the latter case the conduit from the reservoir to the spray tip must be long enough and narrow enough to require a high pressure difference between the source and the exit of the spray needle to maintain a steady flow into the Taylor Cone at the end of the conduit. If that pressure difference is very high relative to the pressure at the needle exit, minor pressure fluctuations at the needle tip or in the ES chamber will not appreciably affect the liquid flow rate. Thus a stable steady flow can usually be maintained for a particular liquid by appropriate choice of reservoir gas pressure. In the case of a positive displacement pump, of course, the liquid flow rate can be maintained at any value for which flow rate and liquid properties are consistent with stability.

Whether it is achieved by a pump or pressurized gas, or by any other means, the flow rate required for stability can be prescribed apriori and a control system can be provided that can maintain the flow rate at the prescribed value. Because the level of thrust from a single spray element is inevitably small, it is very likely that any one vehicle can require a multiplicity of spray elements to provide the variability in magnitude and direction of thrust that may be required.

### PROPULSION EXAMPLE

Electrospray propulsion: 20040226279, by Fenn (FENN). Filed 13 May 2003, discusses a colloidal thruster using capillarity as the sole propellant feed mechanism. Most conventional colloidal thrusters require hydrostatic pressure to feed and effectively operate an electrospray colloidal thruster. U.S. Pat. No. 3,789,608 to Free, issued Feb. 5, 1974, describes a colloidal propulsion emitter surface. Fluid feed is derived from a pressure reservoir where hydrostatic forces channels the fluid into a conductive manifold which communicates with the entrance opening of hollow passageways, typically hollow needles.

FENN states that a capillary alone cannot feed an electrospray source since the capillarity or the level to which a fluid may be raised is determined by several factors. These factors include the ability of a surface to wet the capillary, the cohesive and adhesive forces particular to a given fluid, the capillary diameter, and any gravitational or inertial forces. The meniscus of a fluid in a capillary tube inserted into a reservoir is concave. The electric field of a tube or needle is concentrated on the edge of said tube or needle. Consequently, a concave fluid is effectively shielded from the field and therefore no Taylor Cone can form.

U.S. Pat. Publication No. 2002/0023427 A1 to Mojarradi et al., issued Feb. 28, 2002, and U.S. Pat. No. 6,516,604 B2 to Mojarradi et al., issued Feb.11, 2003, both describe an electrospray colloidal satellite thruster system fabricated using micro electromechanical system (MEMS). This invention suffers from the fact that in order to minimize evaporative losses of the propellant and to maximize the efficiency of each emitter, the feed conduits must be small capillary tubes fed from a pressurized reservoir, where said pressure must be carefully regulated, exhibits a long time constant, and is susceptible to plugging or clogging by dirt.

U.S. Pat. No. 6,825,464: discusses the use of a co-axial fluid, charged by an external electrode, to provide an outer coating of non-volatile fluid to minimize vacuum evaporation. This system is essentially the same as a system developed by Dr. Keady in 1988 [AIAA Student paper, presented at NASA Langley in1988], where a co-axial fluid flow is electrically charged using an external electrode.

Semiconductor Structures Fabrication Technology

An example a conventional semiconductor etching system consists of a mask, light source, a semiconductor, a photoresist, and a plasma or wet etching device. Typically the photoresist (e.g., Fujifilm's FEP-100, FEN-100, GAR Series, GKR Series, ARCH Series, TIS Series; Dow Corning's PWDC-1000, Shin-Etsu MicroSi's SAIL-G series. Equivalents, and other resists as known by one of ordinary skill in the relevant art) is deposited upon layer (e.g., semiconductor, Si, SiO₂, Si₃N₄, GaP, Ge, GaAs, InSb, GaN, AlN, BN, InAs, SiC, Si_{X}Ge_{1-X}, equivalents, and others known by one of ordinary skill in the relevant arts). The light source (e.g., UV light source, laser source) produces light, a portion of which passes through the mask to illuminate patterns on the photoresist. The illuminated patterns are developed by the illuminations. The remainder is washed away leaving raised patterns in the photoresist or the negative thereof (e.g. using a negative photoresist). The patterns are etched into the semiconductor using plasma or wet etching techniques as known by one of ordinary skill in the relevant art of semiconductor etching. Conventional processes require a mask (e.g. lithographic mask), which is typically unique for each pattern, which requires time and money to fabricate the pattern and to monitor pattern quality. Note that the term photoresist is intended to include all fluids and/or materials that can be light, heat, and/or chemically developed, for example silicon oil can be illuminated to form solid SiO2.

Raw and Exotic Material Fabrication

Metals such as steel find their way as construction materials in various shapes and sizes. The steel, while still in the molten stage is poured into ceramic molds that then provide the general final shape of the steel upon cooling. Additionally the steel can be shaped into strips via rollers, while still hot, and then later pounded into various shapes or sold as sheets. Other types of materials (plastics, glass, ceramics (pliable), are likewise in a fluid or pliable state (e.g. by heating)) then molded, shaped, and/or pounded into various shapes by manipulating the liquid (i.e., viscous steel rolling through rollers, or liquid polymer poured into a mold). The fluid can be cured into the desired final shape (e.g., by cooling in the case of heated metals, or heat curing, or UV curing, or a chemical reaction, or other curing processes as known by one of ordinary skill in the relevant art of material processing). In each instance a unique mold or shaping process is needed to acquire a desired shape.

More exotic materials like photonic crystals are conventionally fabricated by etching periodic structures in semiconductors using technology similar to that described above in the section “Semiconductor Structures Fabrication Technology” [Photonic Crystals: The Road from Theory to Practice, Steven G. Johnson, John D. Joannopoulos, ISBN 0-7923-7609-9, 2003, pgs. 118-119] the contents of which, incorporated herein by reference. An alternative conventional method of fabrication is to deposit solid nanospheres into the bottom of a container, then link them into a combined structure. Both of these methods make large scale production photonic materials difficult since each method is conducive to small scale fabrication.

Energy Systems

Typical fusion calculations calculate the temperature (i.e., the kinetic energy) requirements to bring two nuclei together to fuse assuming that each nuclei has a net charge and that the kinetic energy matches the Coulomb force. For example the radius of a deuterium atom is roughly 1.5 fm (femtometer=1×10ˆ-15 m) and the radius of tritium is roughly 1.7 fm. Thus the temperature for fusion will be approximately equal to the temperature needed to overcome the Coloumb force between two positive nuclei and bring them within 3.2 fm. This relationship can be expressed as:

$$2 K . E . \approx k \frac{{e}^{2}}{( {r}_{d} + {r}_{t} )} \approx 0.45 MeV \qquad ( 1 )$$

Where K.E. is the kinetic energy of both nuclei. The temperature of each nuclei can be solved using it's average kinetic energy (half that calculated in (1)):

$$\begin{matrix}\frac{3}{2} kT = 0.22 MeV -> T = \frac{2 K . {E}_{nuclei}}{3 k} \\ = \frac{2 ( 0.22 MeV ) ( 1.6 \times {10}^{- 13} J \text{/} MeV )}{3 ( 1.38 \times {10}^{- 23} J \text{/} K )} = 2 \times {10}^{9} K\end{matrix} \qquad ( 2 )$$

The high temperature has led to the formation of the field of plasma fusion, where physicists are attempting to increase the plasma density and temperature to levels needed to sustain fusion. A certain density is needed for a certain period of time to maintain a steady level of collisions to sustain ignition. J. D. Lawson showed that the product of the ion density n and the confinement time t_{c} should be above a certain level to produce ignition. The relationship can be expressed as:
nt_{c}≧3×10²⁰ s/m³ (3)

In conventional fusion systems the density is either to low, or the temperature not high enough, or the confinement time not high enough.

### SUMMARY OF THE INVENTION

At least one exemplary embodiment is directed toward forming and manipulating an electrified fluid to form structures.

At least one exemplary embodiment is directed toward aphron production using uncharged and/or charge fluid.

At least one exemplary embodiment is directed to a method of structure formation comprising: depositing a first medium on a second medium, where the first medium is charged; shaping the first medium into a pattern, where the pattern is formed by the first medium's reaction to the application by at least one of electric and/or magnetic fields; and developing the shaped first medium.

At least one exemplary embodiment is directed to a method of structure formation, further comprising: etching the shaped first medium forming a similar structure in the second medium.

At least one exemplary embodiment is directed to a structure comprising: a first element, where the first element is formed by developing a pattern that was shaped in a first medium by the application of one of electric and/or magnetic fields, where the first element is formed in a second material by etching the pattern into the second medium.

At least one exemplary embodiment is directed to an apparatus for structure formation comprising: means for depositing a first medium on a second medium; means for charging the first medium; means for shaping a pattern in the first medium using one of electric and magnetic fields; and means for developing the shaped first medium.

At least one further exemplary embodiment is directed to an apparatus for structure formation further comprising: means for etching the shaped first medium to form the pattern in a second medium.

At least one exemplary embodiment is directed to a structure comprising: a first element, where the first element is formed by developing a first medium, where the first medium has been shaped by one of electric and magnetic fields while the first medium had a net charge.

At least one further exemplary embodiment is directed to a structure, where the first medium was charged by using a medium charger, where the medium charger comprises: a medium holder, where the medium holder is configured to hold a first medium; and an electrode, where there is a voltage difference between the electrode and the medium holder, where the first medium is forced out of the medium holder, where the first medium breaks into droplets (e.g., while passing the electrode), where the droplets have a net charge, and where the droplets coalesce into a net charged first medium. In at least one further exemplary embodiment no droplets are formed and the charged first medium is a constant stream, which is deposited. In yet another exemplary embodiment the first medium is a photoresist or optical material that can be developed by light. In yet a further exemplary embodiment the first medium is heat curable.

At least one further exemplary embodiment is directed to a method of structure formation, wherein the second medium is one of a semiconductor, a metal, a glass, a plastic, and a polymer. At least one further exemplary embodiment is directed to a method further comprising neutralizing the developed first medium.

At least one exemplary embodiment is directed to a photonic crystal formed by a method according to at least one exemplary embodiment.

Further areas of applicability of embodiments of the present invention will become apparent from the detailed description provided hereinafter. It should be understood that the detailed description and specific examples, while indicating exemplary embodiments of the invention, are intended for purposes of illustration only and are not intended to limited the scope of the invention.

### BRIEF DESCRIPTION OF THE DRAWINGS

Embodiments of the present invention will become apparent from the following detailed description, taken in conjunction with the drawings in which:

FIG. 1 illustrates the conventional system of 1988;

FIGS. 1A-1C illustrate charged fluid apparatus in accordance with at least one exemplary embodiment;

FIGS. 2A-2D illustrate charged fluid apparatus in accordance with at least one exemplary embodiment;

FIGS. 3A-3C illustrate a charged aphron fluid apparatus in accordance with at least one exemplary embodiment;

FIG. 4A illustrates one apparatus/method for charged material deposition on a substrate in accordance with at least one exemplary embodiment;

FIG. 4B illustrates one apparatus/method for charging a material on a substrate in accordance with at least one exemplary embodiment;

FIG. 4C illustrates one apparatus/method for charging a material on a substrate in accordance with at least one exemplary embodiment;

FIGS. 5A-5C illustrate charged medium molding apparatus/methods in accordance with at least one exemplary embodiment;

FIGS. 6A-6B illustrate charged medium molding apparatus/methods in accordance with at least one exemplary embodiment;

FIGS. 7A-7B illustrate charged medium molding apparatus/methods in accordance with at least one exemplary embodiment;

FIG. 8 illustrates a method of molding a charged medium on a substrate and etching a pattern into the substrate in accordance with at least one exemplary embodiment;

FIG. 9 illustrates the parts of a structure formation apparatus in accordance with at least one exemplary embodiment;

FIGS. 10A-10E illustrate steps in accordance with structure formation in a substrate in accordance with at least one exemplary embodiment;

FIGS. 11A-11B illustrate charged lens formation and manipulation in accordance with at least one exemplary embodiment;

FIG. 12A illustrates a charged aphron formation apparatus in accordance with at least one exemplary embodiment;

FIGS. 12B-12G illustrate aphrons fabricated in accordance with at least a few exemplary embodiments;

FIGS. 13A-13B illustrate aphron fabrication methods in accordance with at least a few exemplary embodiments; and

FIG. 14 illustrates at least one use, collisional studies, for an aphron producer in accordance with at least one exemplary embodiment.

### DETAILED DESCRIPTION OF EXEMPLARY EMBODIMENTS OF THE PRESENT INVENTION

The following description of exemplary embodiment(s) is merely illustrative in nature and is in no way intended to limit the invention, its application, or uses.

Processes, methods, materials and devices known by one of ordinary skill in the relevant arts may not be discussed in detail but are intended to be part of the enabling discussion where appropriate (e.g., the processes and materials in “Principles of Plasma Discharges and Materials Processing”, Michael A. Lieberman, et al., ISBN 0-471-00577-0, 1994). For example the formation of lenses and non-optical structures are discussed and many materials can be used with the methods and devices of exemplary embodiments (e.g., SiO₂, CaCO₃, TiO₂, Al₂O₃, SrTiO₃, MgF₂, LiF, CaF₂, BaF₂, NaCl, AgCl, KBr, KI, CsBr, CsI, Ge, ZnSe, ZnS, Ge/As/Se, GaAs, CdTe, MgO, Polycarbonate, Polystyrene, Polycarbonate, COC™, Acrylic (PMMA), based polymers, photoresist, silicon oil, Si, SiC, CaF, MgF, semiconductors, plastics, polymers, metals, other optical and non-optical materials, other materials that can be etched (e.g., wet, plasma), other materials that can be molded, equivalents, and other materials that one of ordinary skill in the relevant arts would know could be used with methods and devices of exemplary embodiments).

Additionally, the size of structures formed using the methods and devices of exemplary embodiments are not limited by any discussion herein (e.g., the sizes of structures can be macro (centimeter, meter, size), micro (micro meter), nanometer size and smaller).

Additionally, examples of electric and magnetic field generation device(s) are discussed, however exemplary embodiments are not limited to any particular device for generating electric and magnetic fields configured to manipulate charged fluid.

Additionally, discussion herein refers to fluid(s) that are charged, and exemplary embodiments provide several examples of such fluids. However, the present invention is not limited to the mentioned fluids in the examples, and can be any fluid that can be charged (i.e. a + or − net charge) by either electron addition/removal or ion addition/removal. This includes solids that are heated to a fluid state, or gases that are cooled to a fluid state. For example, the Handbook of Chemistry and Physics (HPC) published by CRC Press (e.g. 75^{th} Edition, 1994, ISBN 0-8493-0475-X) provides the resistivity characteristics of many materials that are intended to lie within the scope of at least one exemplary embodiment. For example pg. 12-185, of the 1994 version of the HPC, lists the electrical resistivity of commercial metals and alloys, each of which can be put into fluid form, then manipulated via methods in accordance with at least one exemplary embodiment, with at least one method in accordance with at least one exemplary embodiment using resistivity values to estimate the net charge under the operating conditions.

Additionally although a list of photoresist material has been listed in the background section the present invention is not limited to any such list. A photoresist material can include a fluid that can be light, heat, and/or chemically developed. For example silicon oil can be illuminated with Xe light forming solid SiO2, such a fluid can be charged and used, or used without charging in the exemplary embodiments dealing with aphron formation.

### Exemplary Embodiment Summaries

Exemplary embodiments are provided for illustrative non-limiting purposes only.

The first exemplary embodiment is directed to the formation of a charged medium that can be manipulated (e.g., to form into structures, or to manipulate motion properties of the charged fluid). Several examples are provided of charged medium production devices.

The second exemplary embodiment is directed to the formation of aphrons, either via the charged medium production devices of the first exemplary embodiment or non-charged aphron producing devices. Several examples are provided of aphron production devices.

The third exemplary embodiment is directed to the materials formed by the devices of the first and second exemplary embodiments. Several examples are provided including the example of the mass production of photonic crystal material.

The fourth exemplary embodiment is directed to processes, methods, or devices that use the devices of the first and/or second and/or third exemplary embodiment and/or the materials formed by such devices or methods.

### First Exemplary Embodiment

Charged Fluid Technology

What follows is a general description of the physics involved in charging fluid systems and several relationships that can be used to obtain estimates of the net charge on fluid streams and droplets to design systems in accordance with exemplary embodiments.

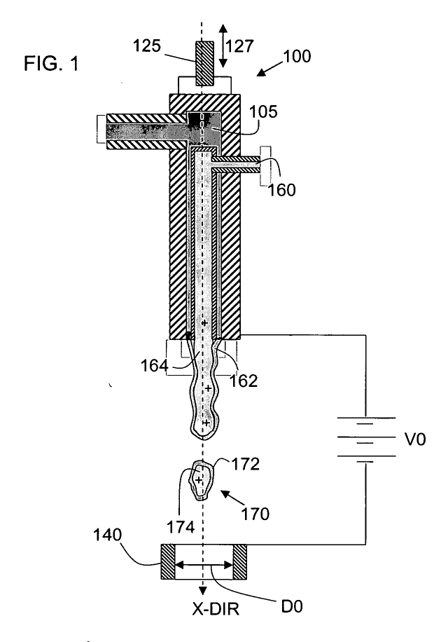

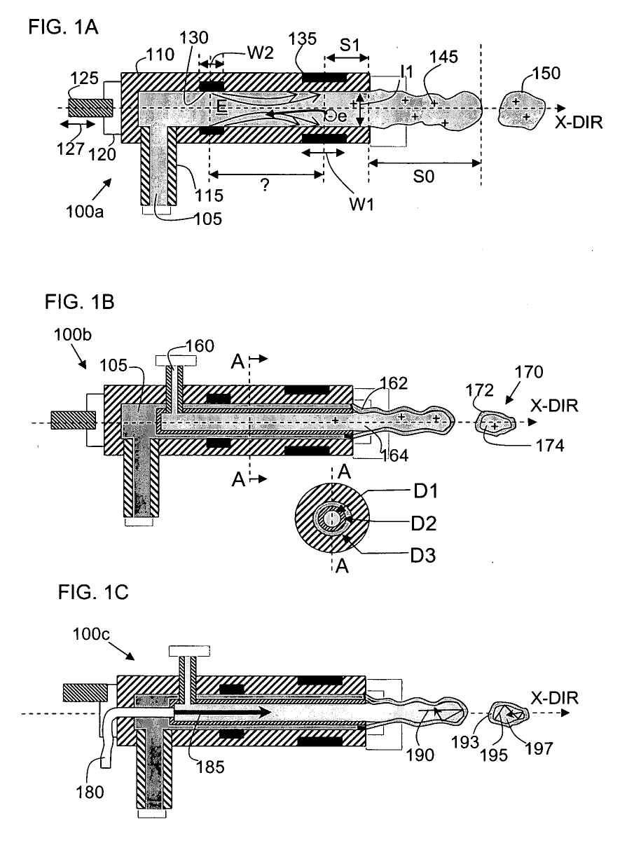

FIGS. 1A and 1B are used to illustrate calculation of the volumetric flow leaving charged fluid production devices or aphron production devices in accordance with at least one exemplary embodiment. FIG. 1A illustrates a charged fluid production system 100a. The fluid 105, injected via an intake channel 115 into reservoir 110, can have a certain conductivity s. When an electric field E is applied across a portion of the fluid 105 the electrons or ions in the fluid 105 move in response. If the fluid 105 breaks into droplets 150 or a separate stream there is a net charge on the droplets 150 or separate stream. The electric field E in accordance with the first embodiment can be created by a voltage difference between electrodes (e.g., 130, 135) or an electrode built into the charged fluid production device 100a or aphron production devices 100b and the fluid reservoir 110 (or intake channel 115). A method that can be used to calculate the net charge is described next.

In this example there is an electric field E between electrodes 130 and 135. The center of the electrodes is spaced ? in the X-direction and t1/2 in the Y direction where t1 is the thickness of the reservoir 110. The Electric field can be approximated by the difference of the voltages V₁₃₅ and V₁₃₀ of the electrodes 135 and 130 respectively divided by the distance ?:
E=(V₁₃₅−V₁₃₀)/?=?V/? (4)

The electric field E drives a current which, as stated above, results in a net charge in any droplet formation. The net charge can be determined using the velocity of the fluid flow between electrodes (e.g., 130, 135). The current travels through the moving fluid until the fluid passes the last electrode. The net charge in the moving fluid will be related to the time ?t it takes the moving fluid to pass both electrodes (i.e. pass through the Electric Field E) and the current driven by the Electric field E. The current j can be expressed as:
j=s E=s(?V/?)=\dot{N}ₑe, where (5)

j is the current density (amp/m³), S is the conductivity (amp/m²Volt), E is the electric field (Volt/m) between electrodes, ?V is the voltage difference between electrodes, ? is the distance (m) between electrodes, \dot{N}ₑ(#electrons/mˆ3 sec), and ‘e’ is an electron charge (e=1.6×10⁻¹⁹ Coulomb/electron). The time it takes a fluid element to pass from one electrode to another can be expressed as:
?t=?/v, where (6)

‘v’ is the velocity of the fluid through the reservoir 110, and ? is the distance between centers of the electrodes (e.g., 130 and 135) in the X-direction. Solving for the total number of electrons that are driven in time ?t, we have:

$${N}_{e} = {\dot{N}}_{e} Δ t = \frac{σ e Δ V}{η} \frac{η}{v} = \frac{σ e Δ V}{v} \qquad ( 7 )$$

The charge per droplet will be:

$${N}_{d} = \frac{{N}_{e}}{1 sec * f} = \frac{σ e Δ V}{1 sec * f * v} , where \qquad ( 8 )$$

f is a disturbance frequency or the number of droplets/sec. Equation 8 provides an estimate of the net charge per droplet, assuming that f droplets are produced per second.

### ILLUSTRATIVE EXAMPLE FOR APPROXIMATING THE CHARGE ON EACH DROPLET

For example assume the fluid is silicon oil and that a shaking device (not shown) is attached to the charged fluid production device 100a (single flow device) via an attachment arm 125 connected to the reservoir 110 by an attachment 120. The shaking device can oscillate at varying amplitudes at varying frequencies. Suppose that the shaking device oscillates in the +/−X-dir with a frequency of f=100 Hz. Suppose also for this non-limiting example that the diameter (I1) of the reservoir is I1=1 mm or 1×10⁻³ m. Also that the voltage difference ?V between the electrodes 135 and 130 is 500 Volts and that the electrodes are spaced ?=10 mm or 1×10⁻² m. Now one can obtain the conductivity s from tables or the manufacturer. To obtain an estimate of the net charge on a droplet, the velocity of the fluid is needed. The velocity “v” can be calculated by comparing the pressure difference ?P between the pressure of the fluid storage (not shown) Pₛ supplying the reservoir and the exit pressure Pₑ, which can be expressed as:

$${P}_{e} + \frac{1}{2} ρ {v}^{2} \approx {P}_{s} , \qquad ( 9 )$$

where Pₑ is the exit pressure

for example atmospheric pressure, Pₐₜₘ. Equation (9) can be solved for the velocity “v” as:

$$v = \sqrt{\frac{2 ( {P}_{s} - {P}_{atm} )}{ρ}} = \sqrt{\frac{2 Δ P}{ρ}} \qquad ( 10 )$$

substituting the expression for the velocity “v” into equation (8) one can solve for the charge per droplet as:

$${N}_{d} = \frac{{N}_{e}}{1 sec * f} = \frac{σ e Δ V}{1 sec * f} \sqrt{\frac{ρ}{2 ( {P}_{s} - {P}_{atm} )}} \qquad ( 11 )$$

The pressure difference can be either set or the size of the droplets can be chosen and the pressure difference calculated from the size. If one assumes that a droplet is spherical in size the volume is:

$$V = \frac{4}{3} {r}^{3} π \qquad ( 12 )$$

Continuing the example, If one assumes just for the example that a droplet size is chosen to be 1 mm in radius. Thus the volume, using equation (12) is 5.23×10⁻¹⁰ m³. If f=100 Hz, there will be approximately 100 droplets/sec. The volumetric flow rate β can be approximated by 100×5.23×10⁻¹⁰ m³/sec. To calculate the velocity needed one can use the desired volumetric flow rate β and the exit area Aₑ=r²p, where r=I1/2:

$$v = \frac{β}{{A}_{e}} = \frac{β}{{r}^{2} π} \qquad ( 13 )$$

Using (13) Aₑ=7.85×10⁻⁷ m², thus v=6.66×10⁻² m/s. For the example then the pressure difference is (using (9) or (10)) ?P=0.5?v² for a particular density ? value. Thus the fluid storage pressure can be set to Pₛ=Pₐₜₘ+?P to obtain the desired velocity fluid flow. Using all of the above information for this non-limiting example, and the conversion of 1 CVolt=1 J the charge per droplet is approximated as:

$${N}_{d} = \frac{σ e Δ V}{1 sec * f * v} = \frac{σ ( 1.6 \times {10}^{- 19} C ) ( 500 Volts )}{( 1 sec ) ( 100 Hz ) ( 6.66 \times {10}^{- 2} m \text{/} s )} , \qquad ( 14 )$$

conductivity can be plugged in to get the charge per droplet.

FIGS. 1A-1C illustrate charged fluid production devices in accordance with at least one exemplary embodiment. FIG. 1A illustrates a charged fluid production apparatus 100a, where the charging electrodes (e.g., 130, 135) are operatively built into the reservoir 110. An applied voltage difference between the first electrode 130 and the second electrode 135 drives a current in the fluid 105 within the region between the electrodes, as described above, leaving a net charge 145 in the fluid that passes the second electrode 135. As the fluid leaves the reservoir 110, the fluid breaks into droplets 150, which carries a net charge. Note that the voltage difference between the first and second electrodes 130 and 135 can be reversed leaving a net negative charge in the fluid 105 passing the second electrode and subsequent droplets 150.

### Second Exemplary Embodiment

FIG. 1B illustrates an aphron production device 100b, that can be a charged aphron production device with the addition of electrodes 130a and 135a. Note that, as with the device illustrated in FIG. 1A, one electrode can be used and voltage biased against the outer reservoir 111 or the inner reservoir 161, without the need for two electrodes. As illustrated in FIG. 1B the aphron production device 100b flows an inner flow 160 into an inner reservoir 161, with an outer flow 105 flowing in an outer reservoir 111. The inner 164 and outer 162 fluid flows out the exit. Without a shaker the combined fluid flow (inner 164 and outer 162 fluid flow) will break up into droplets 170 with combined constituents forming in some cases a core 174 and a sheath 172. With a shaker (e.g., connected to 125), as discussed above with respect to the charged fluid production device 100a, a shaker frequency (e.g., f) along with chosen inner and outer fluid flows can result in predictable substantially uniform aphron production. Where the term aphron is intended to mean a mixed constituent droplet (e.g., a core 174 surrounded by at least one sheath 172) or mixed constituent stream (e.g., 162, 164).

The inner reservoir 161 can have an inner diameter D1, with a thickness bringing the outer reservoir inner diameter to D2. The outer reservoir has an outer diameter D3. The relationship between the fluid flows, shaker frequency, an aphron production can be approximated to be used in exemplary embodiments.

### AN EXAMPLE OF APPROXIMATE APHRON PRODUCTION

The inner 160 and outer 105 fluid flows pass through the exit areas defined by the diameters D1, D2, and D3. For this non-limiting example lets assume that the resultant droplet 170 has a core diameter of 1 mm, with a sheath volume of 3% by volume. The core diameter D_{c} can be related to the core volume by:

$${V}_{c} = \frac{4}{3} {π ( \frac{{D}_{c}}{2} )}^{3} = 5.23 ⨯ {10}^{- 10} {m}^{3} \qquad ( 15 )$$

The shell thickness of the sheath can be approximated by the difference between the inner sheath diameter Dₛᵢ and he outer sheath diameter Dₛₒ:

$${V}_{s} = \frac{4}{3} π [ {( \frac{{D}_{so}}{2} )}^{3} - {( \frac{{D}_{si}}{2} )}^{3} ] = \frac{1}{6} π [ ( {D}_{so}^{3} ) - ( {D}_{si}^{3} ) ] \qquad ( 16 )$$

For simplification if we assume that the inner sheath diameter Dₛᵢ is equal to the core diameter D_{c}, we can then calculate the outer sheath diameter Dₛₒ from our assumption of the sheath volume as:

$${[ \frac{6}{π} ( 0.1 ⨯ {V}_{c} ) + ( {D}_{si}^{3} ) ]}^{\frac{1}{3}} = {[ \begin{matrix}\frac{6}{π} ( 5.23 ⨯ \\ {10}^{- 11} {m}^{3} ) + \\ ( 1 ⨯ {10}^{- 9} {m}^{3} )\end{matrix} ]}^{\frac{1}{3}} = 1.039 ⨯ {10}^{- 3} m = {D}_{so} \qquad ( 17 )$$

The flow rate in the inner reservoir βᵢ and the flow rate in the outer reservoir βₒ can be related to the shaker frequency f; the inner and outer reservoir exits areas Aᵢ and Aₒ respectively; the inner flow velocity vᵢ; the outer flow velocity vₒ; the pressures of the inner and outer fluid storage vessels (not shown) Pᵢ and Pₒ respectively; and the volume of the core V_{c} and sheath volume Vₛ. For example the flow rates βᵢ and βₒ can be related directly to the shaker frequency f and the droplet volumes V_{c} and Vₛ as:
βᵢ=fV_{c} (18)
βₒ=fVₛ (19)

For example if one wishes to produce 100 aphrons per second, with the volume relationships mentioned above, then f=100 Hz, and equations (18) and (19) can be solve to obtain, βᵢ=5.23×10⁻⁸ m³/sec, and βₒ=1.57×10⁻⁹ m³/sec. Now one can use the exit areas to calculate the velocity of the inner vᵢ and the velocity of the outer vₒ fluid flow. For example the following relationships can be used:
βᵢ=vᵢAᵢ and (20)
βₒ=vₒAₒ (21)

The exit areas for the above described example, Aᵢ for the inner reservoir exit area, and Aₒ for the outer reservoir exit area, can be calculated to be, Aᵢ=prᵢ²=7.85×10⁻⁷ m² and Aₒ=p(1/4)(Dₛₒ²−Dₛᵢ²)=6.28×10⁻⁸ m². Using these values as an example one can calculate the velocity rates using equations 20 and 21 to get vᵢ=6.66×10⁻² m/s and vₒ=2.5×10⁻² m/s. The pressure difference between the exit pressure and the storage vessel pressure, associated with the calculated velocities, can be approximated by equation (10),

$$v = \sqrt{\frac{2 ( {P}_{s} - {P}_{atm } )}{ρ}} = \sqrt{\frac{2 Δ P}{ρ}} .$$

Thus the pressure of the storage vessels supplying the inner and outer fluid can be determined from equation (10) using the velocities (e.g., vᵢ and vₒ) and the outer and inner fluid densities respectively ?ₒ and ?ᵢ.

$$Δ P = \frac{{v}^{2}}{2} ρ \qquad ( 22 )$$

For example if we use silicon oil (e.g., silicon oil as described in U.S. Pat. No. 4,119,461) as the outer fluid and water as the inner fluid (?ᵢ=1000 Kg/m³), we get ?Pᵢ=2.218 N/m² for the inner fluid reservoir and the outer fluid pressure can be calculated using the density of the particular silicone oil used.

FIG. 1C illustrates a modification of an aphron production device 100c. The device 100c includes an optical feed 180, which can carry laser light 185. The laser light can travel through the inner fluid flow similar to travel in a fiber optic cable if the difference in the index of refraction of the inner fluid to the index of refraction for the outer fluid is chosen correctly. Choosing the correct difference is the same process as one chooses fiber optic cable and its cladding as known by those skilled in the art to obtain a critical angle that will reduce optical loss along the inner fluid flow. In at least one exemplary embodiment the outer fluid flow is much more conductive than the inner fluid flow and can trap the laser light within a droplet by reflection of the laser light internally. In the extreme case the outer fluid flow is superconductive, ideally trapping the laser light for a prolonged period of time. One method for making the outer flow more conductive than the inner flow is to have each flow have a different conductivity, thus using the same charging electrodes will result in different charge concentrations in each fluid, thus a conductive difference. Another method discussed later is to have separate charging electrodes for the inner and outer reservoirs and hence the inner and outer flows, thus also facilitating different conductance between flows, if desired. This also facilitates the usage of the same fluid for the inner and outer flows but with the outer flow having a different conductance and surfactant level.

### FURTHER EXAMPLES OF FIRST EXEMPLARY EMBODIMENTS

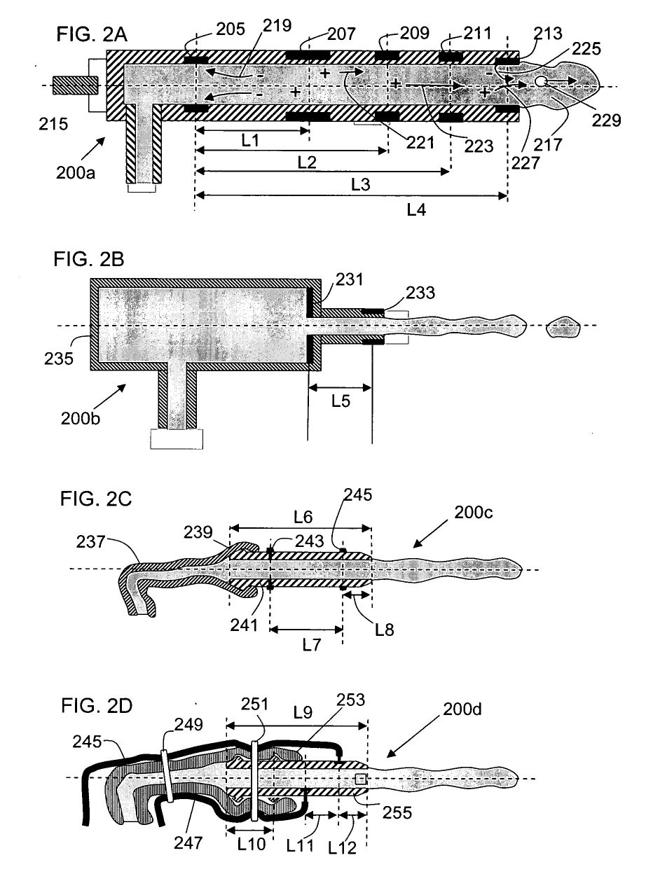

FIGS. 2A-2D illustrate charged fluid devices in accordance with the first exemplary embodiment. FIG. 2A illustrates a charged fluid production device 200a, having several electrodes 205, 207, 209, 211, and 213. The charged fluid production device 200a can have a shaker arm 215 that can be connected to a shaker motor to oscillate the device 200a at a chosen frequency, facilitating uniform droplet formation. The electrodes 205, 207, 209, 211, and 213 can have various voltages differences across various electrodes spacings L1-L4. The voltage differences, as described above, can drive a current 219 through the fluid 217, resulting in a net charge in the fluid after the first set of electrodes is past (e.g., 205, 207). The remaining electrode's voltage difference can drive the charged fluid (e.g., the ions of the fluid) to accelerate the velocity of the fluid. Thus the example of the first exemplary embodiment illustrated in charged fluid production device 200a can be used as a fluid pump. To neutralize the fluid another electrode or set of electrodes (e.g., 213) can drive electrons 225 across the exit area providing electrons 225 to neutralize the ions 227 so that the fluid passing the final electrodes are substantially neutralized 229. Thus this use of the charge fluid production device can be used as a fluid pump (e.g., in a pipe). In such a usage there may be no exit per see, but instead spaced electrodes to charge, pump, and neutralize the fluid. Additionally the example illustrated in FIG. 2A can be used as a water vehicle propulsion system, where the vehicle injects ambient fluid into the vehicle, which then is accelerated by a device similar to that shown in FIG. 2A, then exhausted into the ambient environment.

FIG. 2B, illustrates a second example of a charged fluid production device 200b of the first exemplary embodiment. In this example there are two electrodes 231 and 233, spaced L5, and a reservoir 235. A voltage difference as described above will result in a charged fluid.

FIGS. 2C and 2D illustrate further examples in accordance with the first exemplary embodiment. The charged fluid production device 200c includes a supply tube 237 (e.g., flexible plastic tube) attached 239 (e.g., stretched over a flange to seal) to a base 241 (e.g., an insulative material, glass) of length L6 with electrodes 243 and 245 (e.g., made of copper) spaced L7, where electrode 245 is positioned a distance L8 from one end of the base 241.

FIG. 2D illustrates another example according to the first exemplary embodiment. The charged fluid production device 200d includes a supply tube 253 (e.g., flexible plastic tube) attached 251 (e.g., a band securing the tube 253) to a base 255 (e.g., an insulative material, glass) of length L9 with electrodes spaced L11, where one electrode is spaced L12 from one end of the base 255. The electrodes have leads 245 and 247, which can carry a voltage difference between the electrodes.

### EXAMPLES OF THE SECOND EXEMPLARY EMBODIMENT

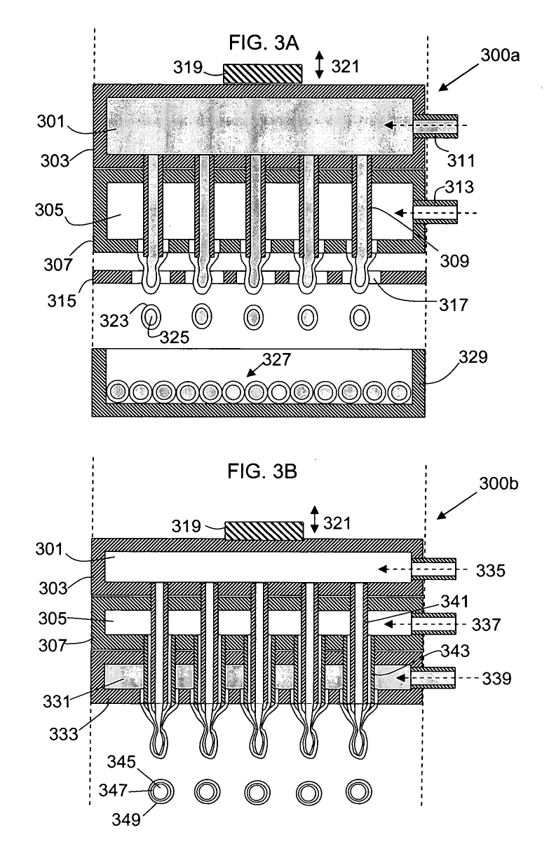

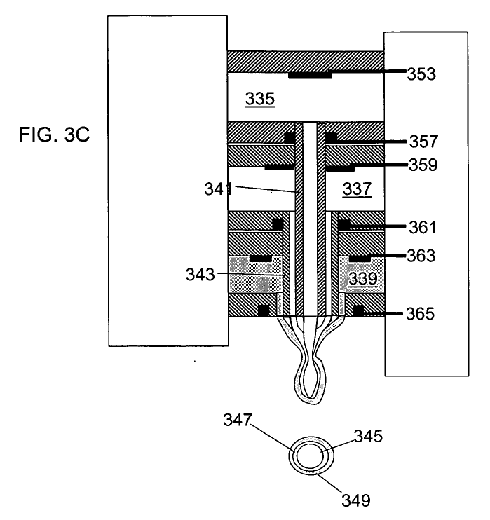

As described above with respect to generating aphrons, several examples in accordance with the second exemplary embodiment are described above (e.g., FIGS. 1B and 1C) and several more non-limiting examples will be described below (e.g., FIGS. 3A, 3B, and 3C).

A two fluid multi-aphron generation device 300a is illustrated in FIG. 3A. Note that more than two fluids can be used with modification of the device 300a to accommodate the additional fluid. The multi-aphron generation device 300a operates similarly as the single aphron generation devices 100b and 100c but generate multiple aphrons contemporaneously. An inner flow 301 and an outer flow 305 enter respective reservoirs 303 and 307 through respective intakes 311 and 313. The inner fluid 301 is transported to the exit region through the outer reservoir 307 via a transport tube 309. An electrode 315 can be provided with openings 317, through which the aphron generating stream passes. A shaker motor can be attached to a shaker arm 319 to shake the device 300a a chosen frequency. A voltage difference between the reservoirs (e.g., 303, 307) and the electrode 315, as described above, will result in a current and a net charge in the aphrons produced. The aphron is composed of a sheath 323 and a core 325. The sheath 323 and core 325 can be net charged positive or negative or have no charge. The produced aphrons can accumulate 327 in a container 329. The inner fluid 301 and the outer fluid 305 can be various types of fluids (e.g., photoresist, silicon oil). The accumulated aphrons 327 can each have a net charge and manipulated by and electric and/or magnetic fields. Likewise the aphrons can be cured to become a solid material (e.g., photonic). The device 300a can produce charged aphrons or uncharged aphrons (e.g., no electrode 315 or no voltage difference).

FIG. 3B illustrates an example of a multi-fluid aphron generation device 300b, which can be shaken 321 at a chosen frequency by a shaker connected to the shaker arm 319. In the example illustrated there are three fluids, an inner fluid 301, a first sheath fluid 305, and a second sheath fluid 331. The inner fluid resides in a first reservoir 303, the first sheath fluid resides in a second reservoir 307, and the second sheath fluid resides in a third reservoir 333. The inner fluid 301 comes from a supply source (not shown) through inlet 335, while similarly the first and second sheath fluids come through inlet 337 and inlet 339 respectively. The inner fluid 301 is transported to the exit via tube 341, while the first sheath fluid 305 is transported to the exit via tube 343. Note that although an electrode is not shown one can be used (e.g., as the device in FIG. 3A) to create charged aphrons. In the particular example illustrated the resultant aphrons have a core 345, a first sheath 347, and a second sheath 349. Although particular fluids for the inner fluid 301, first sheath fluid 305 and second sheath fluid 331 are not discussed many various fluids can be used, as previously discussed (e.g., silicon oil, photoresist).

Note that instead of an external electrode internal electrodes can be used. For example FIG. 3C illustrates a charged multi-fluid aphron generation device. The inner fluid 335 is transported to the exit via tube 341, while a first sheath fluid 337 is transported to the exit via tube 343, and the second sheath fluid 339 surrounds the first sheath fluid and inner fluid at the exit. In the particular example illustrated in FIG. 3C, a pair of electrodes can be used for each fluid. For example a first pair of electrodes 353 and 357 can be used to charge the inner fluid 335, while a second pair of electrodes 359 and 361 can be used to charge the first sheath fluid 337, and a third pair of electrodes 363 and 365 can be used to charge the second sheath fluid 339. Thus in accordance with at least one exemplary embodiment the fluid can be individually charged to different levels. For example the inner fluid 335 can be negatively charged, the first sheath fluid 337 can be neutral and an insulator, and the second (outer) sheath fluid 339 can be positively charged. The aphron has a core 345 made of the inner fluid 335, a first sheath layer 347 made of the first sheath fluid 337, and a second sheath layer 349 made of the second sheath fluid 339.

### SEMICONDUCTOR STRUCTURES FABRICATION EXAMPLE

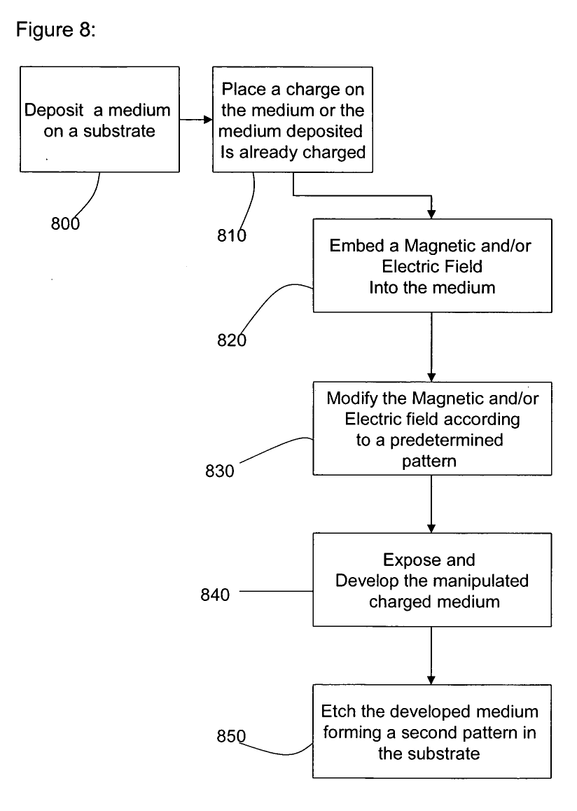

FIG. 8 illustrates a method in accordance with at least one exemplary embodiment. First a medium (e.g., photoresist) is deposited 800 on a substrate. Second, a charge is placed on the on the medium, alternatively the medium can be charged prior to deposition, 810. Third, a magnetic/electric field device embeds, 820, a magnetic and/or electric field into the medium. An example of just a few of many exemplary embodiments of such a device will be discussed below. Fourth, the magnetic/electric device modifies, 830, the magnetic and/or electric field embedded in the medium, forming a predetermined electric/magnetic pattern to which the charge medium reacts forming a second pattern in the charged medium (e.g., the charged medium may not form a pattern that exactly matches the field pattern, thus the charged medium forms a second pattern). Fifth, the patterned medium is exposed and/or developed, 840 (e.g. using UV light, heat cured, cooling, Xe2 light) so that the charge medium retains its shape when the electric and or magnetic fields are removed. Sixth, the developed patterned charged medium can be neutralized, for example via an electron gun, or grounding, or other methods and processes as known by one of ordinary skill in the relevant art, and equivalents. The developed patterned medium can be the desired structure or can be etched (e.g., plasma etching, wet etching, other etching techniques and methods as known by one of ordinary skill in the relevant art, and equivalents) to form a pattern of the structure into the substrate that the developed patterned medium rests upon.

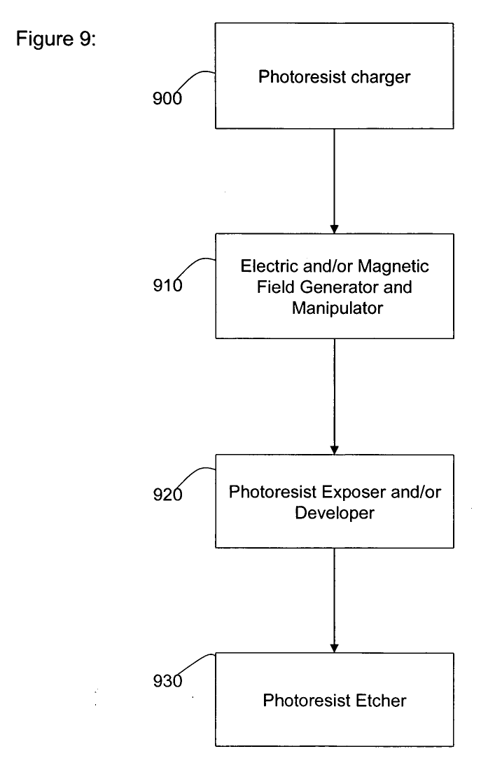

FIG. 9 illustrates parts of at least one exemplary embodiment comprising: a photoresist and/or medium charger 900; an electric and/or magnetic field generator and manipulator 910; photoresist exposer and/or developer 920; and if necessary a photoresist etcher 930.

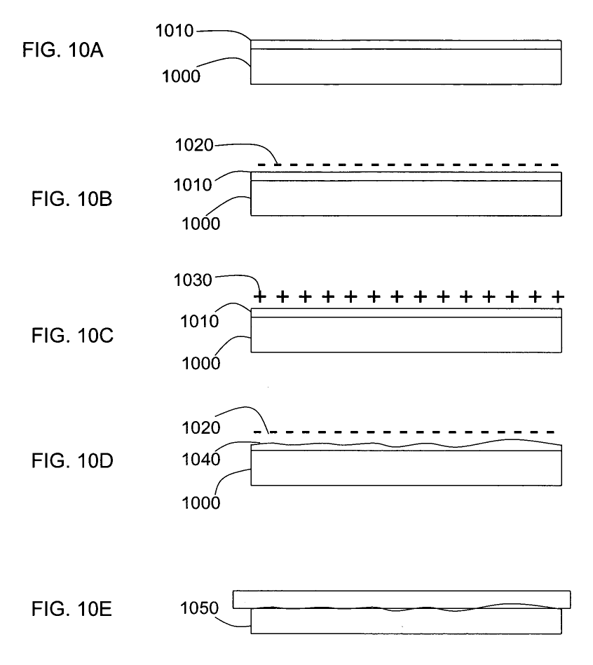

FIGS. 10A-10E illustrates steps in accordance with methods of structure formation in accordance with exemplary embodiments. FIG. 10A illustrates a substrate 1000 with a medium 1010 deposited thereon. A charge (negative (FIG. 10B) or positive (FIG. 10C)) can be placed on/in the medium. FIG. 10D illustrates a negative charged medium which has been manipulated by electric and/or magnetic fields to form a pattern 1040. The patterned medium 1040 can be exposed and/or developed, then the charges neutralized if desired. The structure can be the developed pattern 1040 or the developed pattern (e.g., developed photoresist) can be etched into the substrate 1000 to form a final structure 1050.

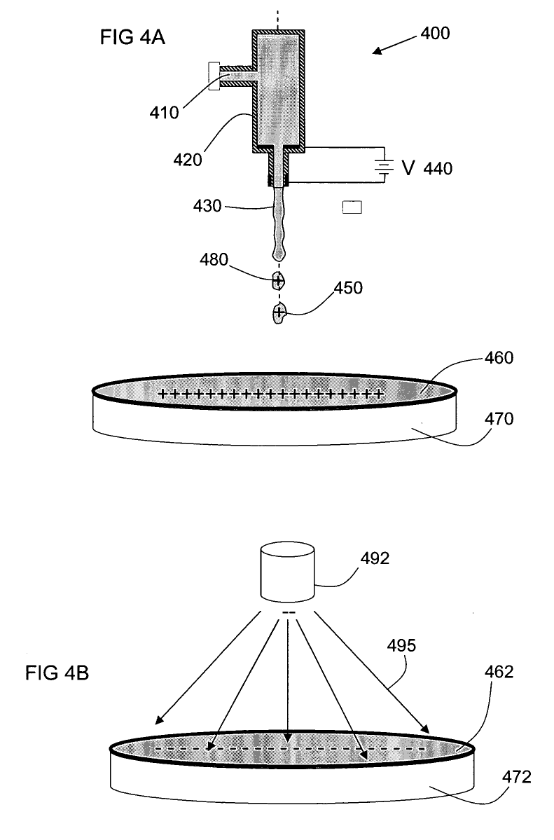

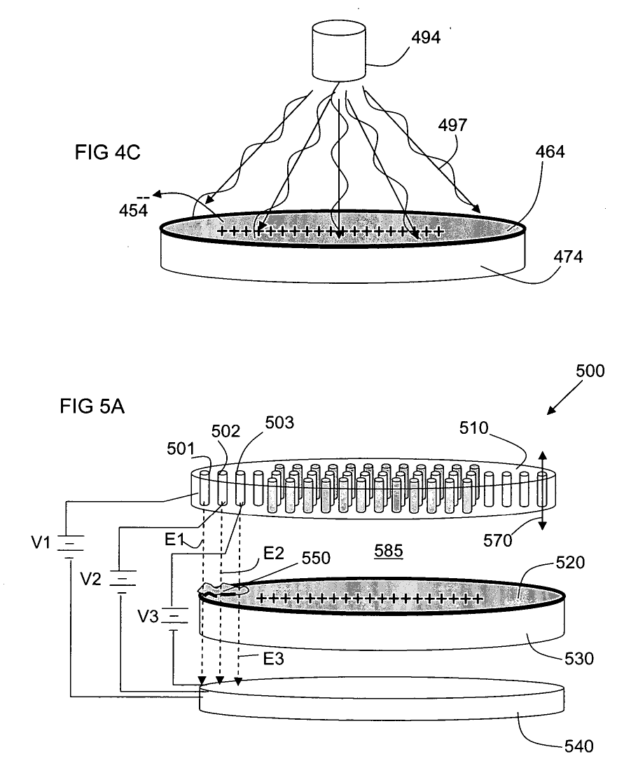

As discussed above there are many methods/devices in accordance with exemplary embodiments to charge a medium. FIGS. 4A-4C illustrate three further examples of charging a medium. The first example of at least one exemplary embodiment is illustrated in FIG. 4A. A medium charger 400 can comprise two separate tubes 410 and 420. A voltage difference 440 is placed between the first tube 410 and the second tube 420. A medium 430 passing through the first tube 410 and between the first tube 410 and the second tube 420 can experience an electric field. The electric field (e.g., potential 440) can drive electrons and/or ions in the medium to a predetermined direction polarizing the medium. When the medium breaks into droplets 480 the drops have a net charge 450. When the drops 480 deposit on a substrate 470, the charged medium will spread because of the net charge, making the charged medium more uniform 460. The tube 410 can be vibrated to make uniform droplets (e.g., the tube 410 can be operatively connected to an arm operatively connected to a shaker motor, or other methods as known by one of ordinary skill, and equivalents). The tubes (e.g., 410 and 420) can be made of various conductive materials (e.g., Cu, Ag, some conductive alloy, other conductive materials as known by one of ordinary skill and equivalents). The medium can be any type of liquefied medium (e.g., photoresist, polymer, silicon oil, other fluids as discussed and known by one of ordinary skill in the relevant art and equivalents) that can be developed (cooled, cured, light developed (e.g., UV, Xe2), or other developing and/or exposing methods as known by one of ordinary skill, and equivalents) and have a charge placed in or on.

A second example of at least one exemplary embodiment of a medium charger is illustrated in FIG. 4B. An electron gun 492 emits electrons 495. At least a portion of the emitted electrons are incident upon a medium 462, placing a net charge on the medium 462. The medium 462 can be deposited on a substrate 472, and subsequently exposed/developed and etched if the structure is to be formed in the substrate 472.

A third example of at least one exemplary embodiment of a medium charger is illustrated in FIG. 4C. An electromagnetic wave generator 494 emits an electromagnetic wave 497 that will not develop medium 464, but can force the emission of electrons 454 charging the medium 464. The wavelength of the light will depend on the work function of the medium 464. The electromagnetic wave can cause the ejection of electrons and a subsequent ambient electric field can sweep the electrons away or keep them away from the medium until final exposure and/or development. After development and/or exposure the medium 464 can be neutralized, for example the developed medium 464 can be grounded or bombarded with electrons.

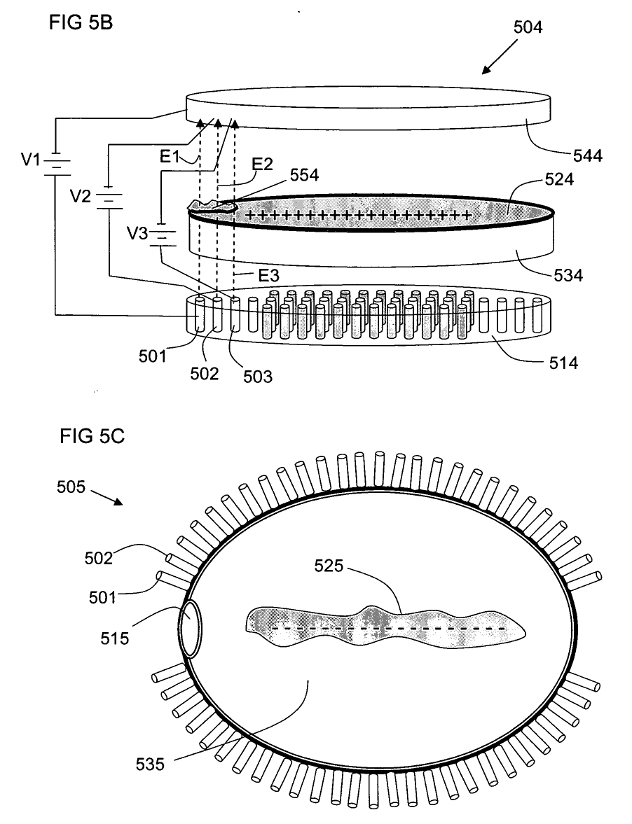

The medium charger can charge a medium which then can be manipulated via electric and/or magnetic fields into a designed shape of pattern. FIGS. 5A-5C illustrate several exemplary embodiments for shaping a pattern in a charged medium. FIG. 5A illustrates a first example of an exemplary embodiment of a device 500 for electric and/or magnetic field manipulation configured to shape a pattern/form into a charged medium. The device 500 can include an upper plate 510 and a lower plate 540. A voltage difference can be placed between the upper plate 510 and the lower plate 540. In additional examples of exemplary embodiments portions of the upper and/or lower plates 510 and 540 can have various voltage differences. The voltage differences (e.g., V1, V2, and V3) can create electric fields and electric field variations (e.g., E1, E2, and E3) in region 585 between the upper 510 and lower 540 plates. A charged medium 520 placed in region 585 can react to the electric field and electric field variations to form the shapes and patterns 550 in the charged medium 520. The charged medium 520 can be deposited on a layer 530, which can be an insulator and/or semiconductor or any other type of material as known by one of ordinary skill in the relevant arts that would not substantially bleed off the charge of the charged medium.

In at least one exemplary embodiment portions of the upper plate 510 and/or the lower plate 540 can be independently charged. For example FIG. 5A illustrates at least one exemplary embodiment containing voltage elements (e.g., 501, 502, and 503). In at least one exemplary embodiment the voltage element can move 570 in relation to the lower plate 540. Changing the relative distance between the voltage elements and the lower plate 540 changes the electric field if the voltage difference remains the same. Thus movements 570 of the voltage elements can change the electric fields (e.g., E1, E2, and E3) and therefore different patterns can be developed using the same setup. Thus, in this exemplary embodiment no new lithographic mask (or any lithographic mask) is needed to form a new pattern in a charged medium that can be etched (e.g., a charged photoresist) or a new pattern in a charged medium that later becomes the final semiconductor with exposure and/or development (e.g., charged silicon oil, which can be exposed by shining Xe2 light).

As previously mentioned the lower plate can contain portions that vary in voltage. FIG. 5B illustrates a second example of at least one exemplary embodiment of an electric/magnetic field manipulation device 504 where the lower plate 514 contains voltage elements (501, 502 and 503), for example the plates are flipped from the example illustrated in FIG. 5A. Note also that both top and bottom plates can have separate voltage elements (not shown). The voltage elements can have various voltage differences (e.g., V1, V2, and V3) in relation to the upper plate 544. A charged medium 524 can be deposited on layer 534. The charged medium 524 can be shaped/formed/patterned 554 by the electric fields formed by the voltage difference of the voltage elements in relation to the upper plate 544. The shaped/formed/patterned 554 charged medium can then be exposed and/or developed.

In another exemplary embodiment, illustrated in FIG. 5C, the charged 575 medium 525 can be injected 515 into a region 535. The region 535 may or may not be deposited on a substrate. For example in a low gravity environment the charged medium 525 may be injected into a region, and held there by electric and/or magnetic fields emitted by the electric/magnetic field device 505 (e.g., having elements 501, 502). Changing the fields can change the pattern in the charged medium 525. Once a desired pattern is achieved, the charged medium can be exposed and/or developed (cooled, cured, other development techniques as known by one of ordinary skill in the relevant arts, and equivalents). The charged developed and patterned medium can then be manipulated via electric and or magnetic fields out of the region, and the process continued if desired. In exemplary embodiments the patterned charged medium can be neutralized.

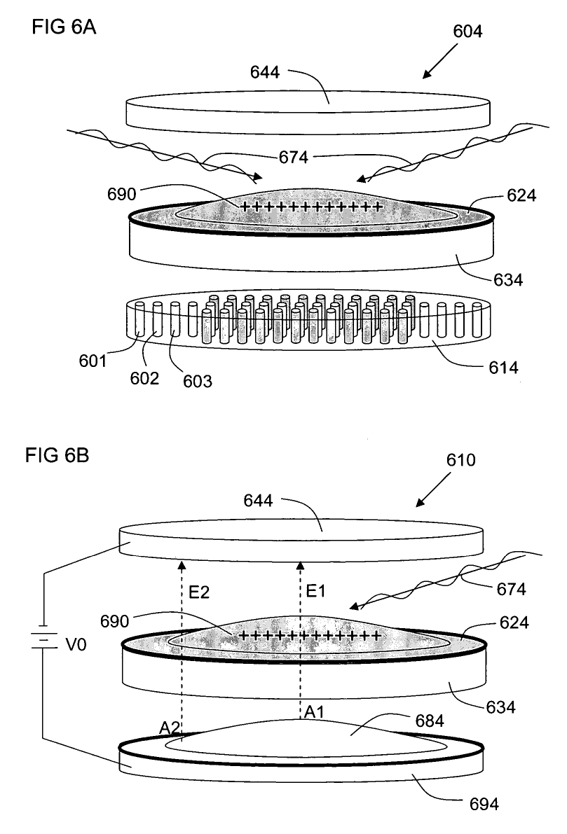

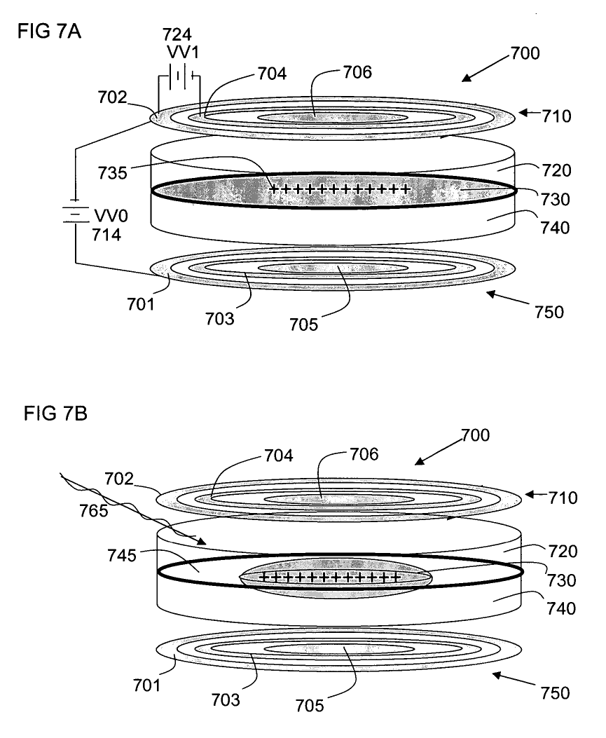

Further examples of exemplary embodiments of electric/magnetic field manipulation devices are illustrated by FIGS. 6A, 6B, 7A and 7B. FIG. 6A illustrates at least one exemplary embodiment 604, where voltage variation between the voltage elements (e.g., 601, 602, and 603) in lower plate 614 can form a lens like element 690, from the charged medium 624 (e.g., charged photoresist, charged silicon oil). The lens like element can be exposed and/or developed (e.g., by UV or Xe2 light 674).

FIG. 6B illustrates another exemplary embodiment 610, where the lens like element 690 is formed by a similar shaped conductive shape 684, which can be deposited on layer 694. The raise portion of the conductive shape A1 can create electric field E1, and a lower portion of the conductive shape A2 can create and electric field E2, which can be different than E1. The difference results in different forces on the charged medium 624 creating the lens like shape/form/pattern 690, which can be developed as discussed above.

FIGS. 7A and 7B illustrate further examples of at least one exemplary embodiment 700. FIG. 7A illustrates a charged (e.g., positive 735) medium 730 floating between two mediums 720 and 740. Two electrode layers 710 and 750 can have various shaped sub electrodes (e.g., 701, 702, 703, 704, 705, and 706). For example electrode layer 710 includes three sub electrodes 702, 704, and 706. While electrode layer 750 includes three sub electrodes 701, 703, and 705. The sub electrodes can vary their respective voltages (e.g., VV0 or 714, and VV1 or 724) changing the electric fields between the two electrode layers 710 and 750. The variation in electric field will change the shape of the charged medium 730 as illustrated in FIG. 7B. The shaped charged medium can then be cured (e.g., illuminated by light 765), exposed, or otherwise developed as known by one of ordinary skill in the relevant arts.

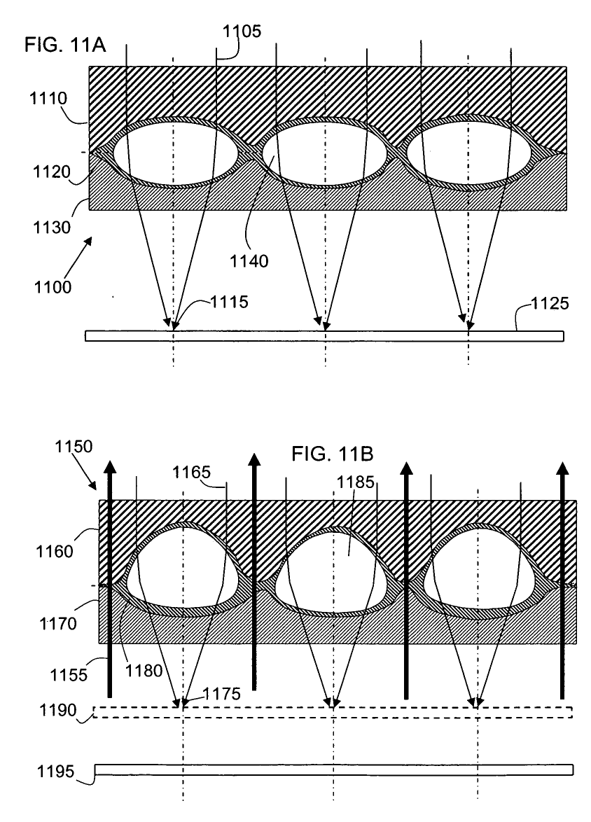

A combination of the first and second exemplary embodiment is illustrated in FIGS. 11A and 11B. Three lens aphrons 1100 are formed containing an outer sheath 1120 and an inner core 1140. In the non-limiting example illustrated the aphrons are sandwiched between a top layer 1110 and a bottom layer 1130 (e.g., difference specific weight fluids). Light 1105 passing through the aphron lens is condensed unto an image plane 1125 at an image and/or focal point 1115. If an electric charge is placed on the core 1140, and an Electric field imposed 1155, the core can distort 1185, as will the sheath 1180. If the sheath is less conductive than the core the net charge of the core will be maintained for a predictable amount of time.

As the sheath 1180 and core 1185 deform into the first layer 1160 and the second layer 1170 the incident light 1165 is refocused/reimaged 1175 to a new image/focal plane 1190. Thus, at least one example of at least one exemplary embodiment is a deformable lens whom's focus is controllable via an external field strength. The amount of distortion can be calculated roughly by balancing surface tensions of the first layer 1160, second layer 1170, sheath 1180, core 1185, and respective gravitational weights with the Electric force. If we assume for example purposes that FIG. 11A illustrates the equilibrium condition and associated shapes, then a distortion from the shapes will result in a force to return that distortion to the equilibrium shape. If the force that occurs to return a distortion back into the equilibrium shape is balanced by the Electric force created by the imposed electric field 1155 on the charge density distributed throughout the core 1185, the distorted shape will become the new equilibrium shape. Similarly for a charged medium on a substrate. To distort the shape the locally applied electric field force can balance the increase in thickness of the charged fluid column locally. In other words if the electric field applied to a charged medium on a substrate makes the charged fluid at a point on the substrate increase in thickness, then the increase in thickness will continue until the gravitational force balances the electrically applied field force. Thus, the desired shapes can be calculated by balancing such forces. Thus in accordance with at least one exemplary embodiment various charged fluid shapes can be made via imposing a patterned electric field on a charged medium which can then be exposed/developed to form a stable pattern even when the field is removed.

### EXAMPLES IN ACCORDANCE WITH THE THIRD EXEMPLARY EMBODIMENT

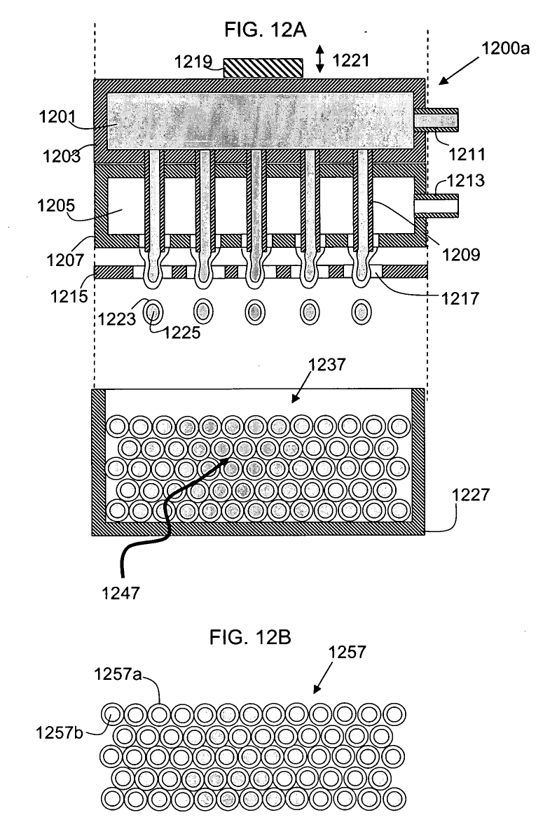

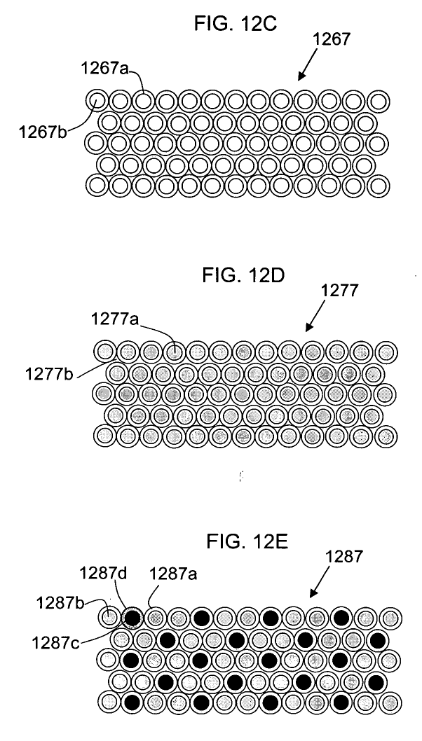

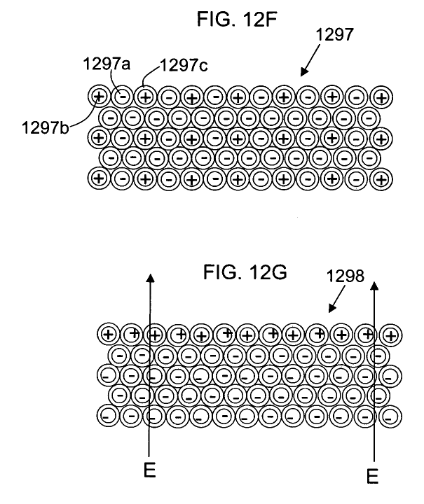

A two fluid multi-aphron generation device 1200a is illustrated in FIG. 12A. Note that more than two fluids can be used with modification of the device 1200a to accommodate the additional fluid. The multi-aphron generation device 1200a operates similarly as the device 300a. An inner flow 1201 and an outer flow 1205 enter respective reservoirs 1203 and 1207 through respective intakes 1211 and 1213. The inner fluid 1201 is transported to the exit region through the outer reservoir 1207 via a transport tube 1209. An electrode 1215 can be provided with openings 1217, through which the aphron generating stream passes. A shaker motor can be attached to a shaker arm 1219 to shake the device 1200a a chosen frequency. A voltage difference between the reservoirs (e.g., 1203, 1207) and the electrode 1215, as described above, can result in a current and a net charge in the aphrons produced. The aphron is composed of a sheath 1223 and a core 1225. The sheath 1223 and core 1225 can be net charged positive or negative or have no charge. The produced aphrons can accumulate 1237 in a container 1227. The inner fluid 301 and the outer fluid 1205 can be various types of fluids (e.g., photoresist, silicon oil). The accumulated aphrons 1227 can each have a net charge and manipulated by and electric and/or magnetic fields. Likewise the aphrons can be cured to become a solid material (e.g., photonic). The device 1200a can produce charged aphrons or uncharged aphrons (e.g., no electrode 1215 or no voltage difference). As in device 300a when aphrons are produced the outer fluid has surfactants dissolved such that the surface tension is enhanced so that the resultant aphrons are long lived (for example, more than 1 second, a few minutes, hours, days, and weeks, depending upon the aphron usage). For example if the aphrons are to be cured (e.g., Xe2 light 1247) then the aphrons must live (e.g., not “pop”) before the aphron is cured by the Xe2 light, this is on the order of a few minutes.

In the example illustrated in FIG. 12A, the accumulated aphrons pile up forming a periodic or semi-periodic structure. Upon curing or development so that the aphrons are now at least partially solid or gell, the structure 1257 can be removed. The structure is formed of the cured/exposed/developed aphrons having sheath 1257a and core 1257b, both of which can be different materials. For example the sheath can be photoresist material curable by UV light while the core can be silicon oil curable by Xe2 light. If the aphrons are small enough (for example, <100 micrometers) then the structure can be a photonic crystal having a photonic band gap. The properties of the structure can be varied to tailor the band gap to the desired frequencies, for example the size of the aphrons can be reduced or increased, and the index of refraction varied by adding additive to the fluids before curing or by choosing different fluids with the desired index of refraction properties upon curing. Note that the term curing is used loosely to refer to all methods of development, for example via heat, by light, by chemical reaction, and other methods as known by one of ordinary skill in the relevant art.

FIGS. 12C-12E illustrates examples of various structures that can be formed. In FIG. 12C the structure 1267 has a cured sheath 1267a, with a gaseous core 1267b.

FIG. 12D illustrates a structure 1277 having a fluid core 1277a and a solid sheath 1277b.

FIG. 12E illustrates a non-homogeneous periodic structures where some of the aphrons are made of different materials than tier immediate neighbors in the structure 1287. For example some aphrons in structure 1287 has a first medium for a first aphrons core 1287c, for example silicon oil cured to SiO2, with a first sheath material 1287d, for example cured photoresist. A second aphron in structure 1287 can have a core made of a second core material, for example cured photoresist, and a second sheath material, for example silicon oil cured to SiO2. Thus various combinations of photonic crystal properties can be designed if the various aphrons can be dispersed throughout the structure or in definable layers.

FIG. 12F illustrates just one method in accordance with at least one exemplary embodiment to selectively place various property aphrons in different locations in structures (e.g., photonic crystals). The structure 1297 is similar to structure illustrated in FIG. 12E, where the either the first or second aphron has a core charge different than the other aphron. If the sheath 1297c is an insulator then the cores will maintain their charges for a time. The variation in aphron core charged can eb accomplished for example by oscillating the electrode polarity in the charged aphron devices discussed above. In the example illustrated the first aphron has a + core charge 1297b while the second aphron has a − core charge 1297a. When the structure is disturbed (e.g., lightly mixed before curing) the charged cores will distribute themselves to an equilibrium condition. Once distributed the aphrons can be cured and either the charges maintained or allowed to bleed off over time. For example if the aphrons are small enough quantum dots can be formed by the charges cores. Thus in at least one exemplary embodiment charged aphrons that are curable by the sunlight can be deposited on objects to provide a coating of quantum dots. Additionally the aphron cores can contain gain material for forming small photonic crystal lasers.

FIG. 12G illustrates a further example where an electric field E has been applied to force the positive core aphrons in one direction and the negatively charge aphrons in the opposite direction. Note if the surface tensions are large enough and the core charge low enough similarly negative aphrons can exist next to each other stably. Thus via this method waveguides in the photonic crystal can be formed. For example the positive charge aphrons may not be curable while the rest are. Thus upon curing and cleaning a channel can exist where the uncurable aphrons were, forming an air channel. Additionally the charged properties of the sheaths and cores can be varied to position electrode aphrons next to aphrons having gain material, forming photonic crystal lasers. For example a bottom layer can be deposited with electrode aphrons positioned then cured. Then an intermediate layer can be deposited on top with gain aphrons serving as laser cavities, the intermediate layer cured. Then an electrode layer can be deposited on top and cured forming a photonic crystal having aphron electrode pairs associated with a laser cavity aphron.

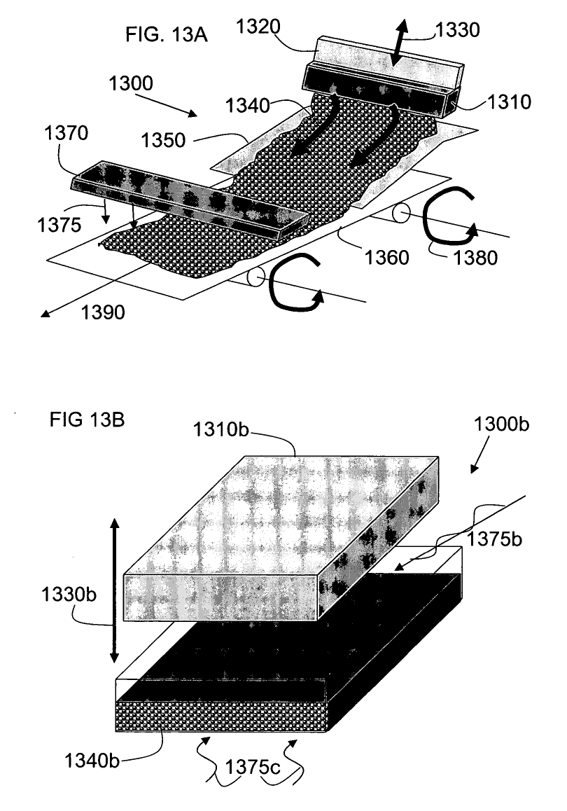

Devices such as device 303a and 1200a can be used to mass produce material made from aphrons. For example FIG. 13A illustrates a conveyor belt type production capacity 1300. A multi-aphron production device 1310 shaked 1330 at a designed frequency by the connection 1320 of a shaker motor (not shown) with device 1310. The produced aphrons flow down 1340 a slide 1350, which can move onto the main belt 1360, which moves due to rotation 1380 of supporting rollers. The aphrons then pass under a developer (e.g. Xe2 light, UV light, heat lamp) 1370 which cures 1375 the aphrons into a semi-finished material which moves 1390 to a cutting region (not shown). Note also that the aphrons can also be slowly deposited onto a form and cured taking the shape of the form, or even deposited into a mold and then cured.

FIG. 13B illustrates yet another example in accordance with at least one exemplary embodiment. The system 1300b illustrated has an aphron production unit 1310b, which can be shaked 1330b, depositing a layer of aphrons into a mold 1340b (e.g., rectangular mold). The aphrons can be cured from various directions depending upon the penetration of the method of curing. For example light can illuminate from the top 1375b to cure the aphrons or from the bottom 1375c (e.g., heat). Thus in accordance with the third and fourth exemplary embodiments various materials can be formed via the processes described and their equivalents.

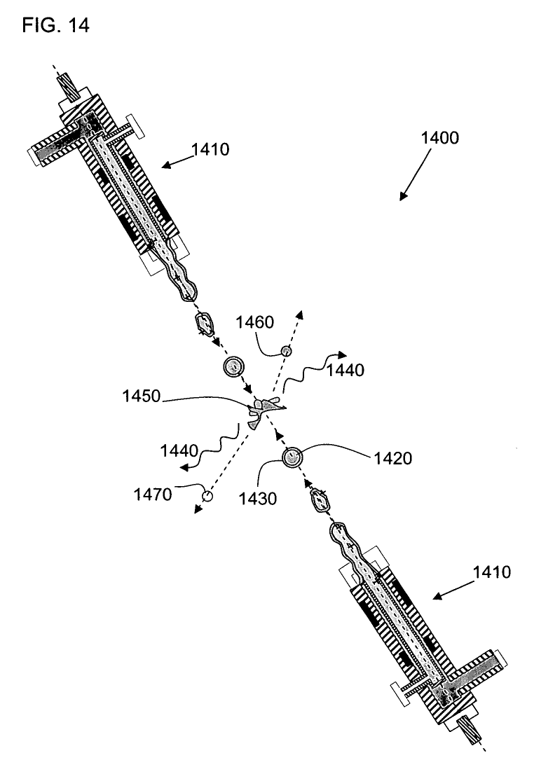

Additionally various devices can use the devices of the first and second exemplary embodiment and/or materials of the third exemplary embodiment. For example FIG. 14 illustrates a pair of aphron production devices 1410 used to generate charged ap[hrons that can then be accelerated toward each other to study fluid collisional effects. For example if the aphron cores of both are composed of charge deuterium water the cores can be accelerated toward each other to study whether equation 3 can be satisfied and a fusion device constructed based upon charged accelerated aphrons. To aid in the combination one core can be negatively charged while the other is positively charged. The cores can be covered with a non-volatile sheath whom's surface tension and anti-evaporation criteria can keep the aphron together during acceleration. Such a device upon collision 1450 could result in gammas rays 1440, and products 1470 and 1460, which could contain trace amounts of fusion byproducts. The collision area could be surrounded by a heat exchange chamber to drive an electric generator and produce electricity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A method of structure formation comprising:
depositing a first medium on a second medium, wherein the first medium is charged;
shaping the first medium into a pattern, wherein the pattern is formed by the first medium's reaction to the application by at least one of electric and magnetic fields; and
curing the shaped first medium, wherein the cured shaped medium substantially retains it's shape upon removal of the fields.

2. The method of claim 1, further comprising:
etching the shaped first medium forming a similar structure in the second medium.

3. A structure comprising:
a first element, wherein the first element is formed by curing a first medium, where the first medium has been shaped by at least one of electric and magnetic fields while the first medium had a net charge.

4. The structure according to claim 3, wherein the first medium was charged by using a medium charger, wherein the medium charger comprises:
a medium holder, wherein the medium holder is configured to hold a first medium; and
an electrode, wherein there is a voltage difference between the hoop electrode and the medium holder, where the first medium is forced out of the medium holder and becomes charged due to the voltage difference, and where the electrode is operatively connected to the medium holder.

5. The structure according to claim 4, where the first medium breaks into droplets after passing through the electrode, where the droplets have a net charge, and where the droplets coalesce into a net charged first medium.

6. The structure according to claim 3, wherein the first medium is one of a photoresist material and an optical material that can be cured by light.

7. The structure according to claim 3, wherein the first medium is heat curable.

8. The method according to claim 2, wherein the second medium is one of a semiconductor, a metal, a glass, a plastic, and a polymer.

9. The method according to claim 2, further comprising:
electrically neutralizing the developed first medium.

10. The structure according to claim 3, wherein the first medium is one of a semiconductor, a metal, a glass, a plastic, and a polymer.

11. A method of aphron production comprising:
flowing a core medium through an inner channel;
flowing at least one sheath medium through at least one outer channel, wherein the at least one outer channel surrounds a portion of the inner channel;
shaking the inner and outer channels at a design frequency f, wherein the core medium and at least one sheath medium flows into a third exterior medium, wherein upon flowing into the exterior medium aphrons are formed, wherein the aphrons have a core which includes the core medium and at least one sheath composed of the at least one sheath medium, and wherein the number of aphrons per second is about the same number as the design frequency f multiplied by one second.

12. The method of aphron production according to claim 11, wherein a first voltage difference is placed across one of the at least one outer channel, so that the sheath medium corresponding to the one of the at least one outer channels is charged.

13. The method of aphron production according to claim 12, wherein a second voltage difference is placed across inner channel, so that the core medium is charged.

14. The method of aphron production according to claim 11, further comprising:
accumulating the aphrons; and
curing the aphrons, so that at least a portion of the aphrons become a solid or gell.

15. The method of aphron production according to claim 12, further comprising:
accumulating the aphrons; and
curing the aphrons, so that at least a portion of the aphrons become a solid or gell, and wherein a portion of the cured aphrons retain a portion of their electrical charge.

16. The method of aphron production according to claim 15, further comprising:
varying the first and second voltage difference in time, wherein the varying produces aphrons of varying electrical net charges;
applying an electrical field to accumulated aphrons, wherein the applied electric field moves aphrons having more charge in first direction; and
curing the aphrons, so that at least a portion of the aphrons become a solid or gell, and wherein a portion of the cured aphrons retain a portion of their electrical charge.
